(19) United States
(12) Patent Application Publication
(10) Pub. No.: US 2015/0169003 A1
(43) Pub. Date: Jun. 18, 2015

(54) DISPLAY DEVICE

(71) Applicant: SHENZHEN CHINTAR CPTOELECTRONICS TECHNOLOGY CO., LTD., Shenzhen (CN)

(72) Inventors: Xiaoping Tan, Shenzhen (CN); Yu-Yeh Chen, Shenzhen (CN); Xia Tian, Shenzhen (CN)

(21) Appl. No.: 14/233,771

(22) PCT Filed: Dec. 17, 2013
(86) PCT No.: PCT/CN13/89727

§ 371 Date: Jan. 20, 2014

(51) Int. Cl. G06F 1/16; G06F 13/372; G09G 3/36

(52) U.S. Cl. CPC G06F 1/1637; G09G 3/3611; G06F 13/372; G09G 2320/0673; G09G 2300/0408; G09G 2310/08

(57) ABSTRACT

A display device includes a first printed circuit board and a second printed circuit board. The first printed circuit board includes a storage unit for storing parameters which are used for driving a display panel. The second printed circuit board includes a programmable gamma IC and a timing controller for receiving the parameters stored in the storage unit. In production of the display device, after a display panel is bonded to the first printed circuit board, the storage unit with the pre-written parameters is deployed on the first printed circuit board. Next, the display panel and the first printed circuit board are connected to the second printed circuit board. Typically, the connection is accomplished by manual operation. Therefore, the problem that the storage unit and the display panel of the display device are incorrectly assembled together can be avoided.

### FIELD OF THE INVENTION

The present invention relates to a display device, in particular to a display device in which a problem that a display panel and a printed circuit board (PCB) are incorrectly assembled together in assembly is prevented.

### BACKGROUND OF THE INVENTION

As the demand for liquid crystal display panels with larger sizes is getting larger and larger in the consumer market in recent years, the manufacture of the liquid crystal display panels tends to be developed in large-size products. The structure of the display devices is changed when the size of the display devices increases from small to large. As shown in FIG. 1, a prior art display device 100 with a large size includes a display panel 110, an X-board (hereinafter referred to as “first printed circuit board 130”), and a CB PCB or a SOC PCB (hereinafter referred to as “second printed circuit board 140”). In the production for bonding the display panel 110 to the first printed circuit board 130, a flexible printed circuit board 180 is used. Afterwards, the display panel 110 and the first printed circuit board 130 are connected to the second printed circuit board 140 by wiring a serial data line (SDA) and a serial clock line (SCL) (not shown). Typically, the connection is accomplished by manual operation.

In the prior art display device 100 with a large size, the second printed circuit board 140 comprises a programmable gamma IC 160, a timing controller 170, and storage units 151 and 152. The programmable gamma IC 160 is used for adjusting a gamma parameter which is to be transmitted to a driving circuit 120. The gamma parameter is stored in the storage unit 151 (such as EEPROM) in the programmable gamma IC 160. The timing controller 170 is used for sequentially controlling driving signals which are to be transmitted to the driving circuit 120. The timing controller 170 controls the display panel 110 according to the parameters, corresponding to optical properties, of the display panel 110. The parameters include values of an OD (overdrive) look-up table, a color look-up table, a de-mura look-up table, etc. The above mentioned parameters are stored in the storage unit 152 (such as EEPROM).

Each of the parameters, corresponding to optical properties, in differing display panels is slightly different, so each display panel has corresponding parameter tables. The parameter tables are stored in the storage unit 151 of the programmable gamma IC 160 and the storage unit 152 of the timing controller 170.

The function of the first printed circuit board 130 is passing the signals received from the second printed circuit board 140 to the driving circuit 120. Typically, the driving circuit 120 is deployed at the border of the display panel 110 and the first printed circuit board 130.

In the manufacture process of the large size display panel 110, after the display panel is bonded to the driving circuit 120, the driving circuit 120 is bonded to the first printed circuit board 130. The parameters stored in the storage units 151/152 will be measured. After measuring, the parameters are written to the corresponding second printed circuit board 140.

The display panel 110 is matched to the particular second printed circuit board 140. However, as the division of labour becomes more complex in the production process, the places of manufacturing the display panel 110 and the second printed circuit board 140 may be different. The second printed circuit board 140 needs to be marked for corresponding to the display panel 110 when the parameters are written to the storage units 151/152 of the second printed circuit board 140. The display panel 110 needs to match the corresponding second printed circuit board 140 according to the mark before assembly. If the display panel 110 and the second printed circuit board 140 are incorrectly assembled together, it will cause a significant deviation in the display effect of the display panel 110. A solution for solving the above display problem caused by incorrect assembly must be provided.

### SUMMARY OF THE INVENTION

The object of the present invention is to provide a display device wherein a storage unit which stores parameter tables of a relevant display panel is deployed on a first printed circuit board connected to a driving circuit. The second printed circuit board is only used for receiving the parameters from the storage unit, so that the display problem that the second printed circuit board, the first printed circuit board, and display panel being are incorrectly assembled together is prevented.

To achieve the above object, the present invention provides a display device, including a display panel having a plurality of pixels, a driving circuit for generating a plurality of driving signals to drive the pixels of the display panel, a first printed circuit board electrically connected to the driving circuit, a storage unit deployed in the first printed circuit board for storing parameters which are used for driving the pixels of the display panel, and a second printed circuit board electrically connected to the first printed circuit board for receiving the parameters stored in the storage unit. The second printed circuit board includes a programmable gamma IC, a timing controller, and an inner-integrated circuit, wherein the timing controller is connected between the programmable gamma IC and the storage unit. The timing controller receives a portion of parameters from the storage unit, and the programmable gamma IC receives another portion of parameters from the storage unit through the timing controller. The programmable gamma IC receives the parameters by the inner-integrated circuit which is deployed in the programmable gamma IC.

The present invention further provides a display device, including a display panel having a plurality of pixels, a driving circuit for generating a plurality of driving signals to drive the pixels of the display panel, a first printed circuit board electrically connected to the driving circuit, a storage unit deployed in the first printed circuit board for storing parameters which are used for driving the pixels of the display panel, and a second printed circuit board electrically connected to the first printed circuit board for receiving the parameters stored in the storage unit.

According to an aspect of the present invention, the second printed circuit board includes a programmable gamma IC connected with the storage unit for receiving a portion of parameters from the storage unit, and transmits the same to the driving circuit for generating driving signals.

According to another aspect of the present invention, the second printed circuit board includes a programmable gamma IC and a timing controller, wherein the programmable gamma IC is connected with the storage unit for receiving a portion of parameters from the storage unit, and the timing controller is connected with the storage unit for receiving another portion of parameters from the storage unit.

In the above-described display device, the second printed circuit board further includes an inner-integrated circuit. The programmable gamma IC receives the parameters from the storage unit by the inner-integrated circuit.

In the above-described display device, the inner-integrated circuit is deployed in the programmable gamma IC.

According to another aspect of the present invention, the second printed circuit board includes a timing controller connected with the storage unit for receiving a portion of parameters from the storage unit, and transmits the same to the driving circuit for generating driving signals.

According to another aspect of the present invention, the second printed circuit board includes a programmable gamma IC and a timing controller, wherein the timing controller is connected between the programmable gamma IC and the storage unit. The timing controller receives a portion of parameters from the storage unit, and the programmable gamma IC receives another portion of parameters from the storage unit through the timing controller.

In the above-described display device, the second printed circuit board further includes an inner-integrated circuit. The programmable gamma IC receives the parameters by the inner-integrated circuit.

In the above-described display device, the inner-integrated circuit is deployed in the programmable gamma IC.

According to another aspect of the present invention, the parameters stored in the storage unit include at least one kind of values of an overdrive look-up table, a color look-up table, and a de-mura look-up table.

The object of the present invention is to provide a display device for solving the problem due to the mismatch between the display panel and the second printed circuit board. As compared with the prior art, the storage unit stores the parameter tables. However, in the present invention it is deployed on the first printed circuit board connected to the driving circuit, and the second printed circuit board is only used for receiving the parameters from the storage unit, so that the problem that the display panel and the second printed circuit board are incorrectly assembled together can be prevented.

In order to make the present invention more clear, preferred embodiments, and the drawings thereof, are described in detail below.

### BRIEF DESCRIPTION OF THE DRAWINGS

FIG. 1 shows a prior art display device.

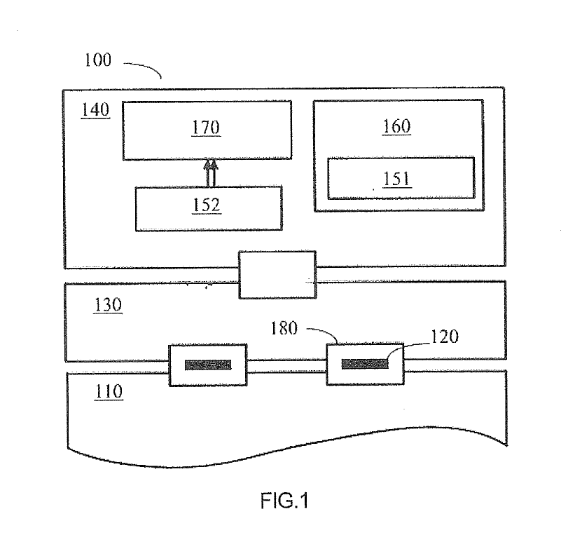

FIG. 2 shows a first embodiment of the present invention.

FIG. 3 shows a second embodiment of the present invention.

### DETAILED DESCRIPTION OF THE INVENTION

In the specification, the terms “a” and “an” do not mean quantitative restrictions, but rather indicate the presence of at least one of the referenced item.

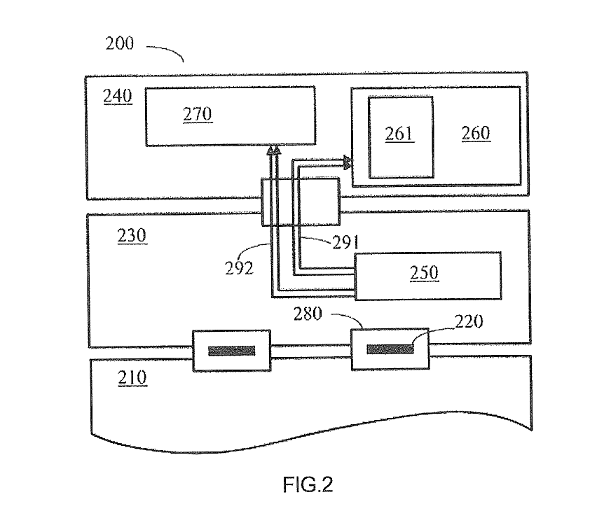

FIG. 2 shows a display device 200 according to an embodiment of the present invention. The display device 200 includes a display panel 210, a first printed circuit board 230, and a second printed circuit board 240. A storage unit 250 is deployed on the first printed circuit board 230. A programmable gamma IC 260, a timing controller 270, and an inner-integrated circuit 261 are deployed on the second printed circuit board 240. After the display panel 210 is bonded to the first printed circuit board 230 by a flexible printed circuit board 280, the display panel 210 and the first printed circuit board 230 are connected to the second printed circuit board 240 by wiring a serial data line (SDA) and a serial clock line (SCL) (not shown). Typically, the connection is accomplished by manual operation. A driving circuit 220 is deployed on the flexible printed circuit board 280 for transmitting driving signals to a plurality of signal lines (not shown) in the display panel 210.

Because each display panel has slight difference from others in optical properties, each display panel has corresponding parameter tables (i.e. a gamma table, an overdrive table, a color table, and a de-mora table). The parameter tables are stored in the storage unit 250. In general, the parameter tables will be pre-written to the storage unit 250, and then the storage unit 250 is deployed on the first printed circuit board 230. The programmable gamma IC 260 and the timing controller 270 are deployed on the second printed circuit board 240. In production, after the display panel 210 is bonded to the first printed circuit board 230 by the flexible printed circuit board 280, the storage unit 250 with the pre-written parameters is deployed on the first printed circuit board 230. Next, the display panel 210 and the first printed circuit board 230 are connected to the second printed circuit board 240 by wiring the serial data line and serial clock line (not shown). Typically, the connection is accomplished by manual operation. Based on the deployment of the present invention, the storage unit 250 with the pre-written parameters is deployed on the first printed circuit board 230, thus the problem that the second printed circuit board 240 and display panel 210 are incorrectly assembled together in assembly is prevented.

Now the driving process of the display panel 110 is described as follows. The inner integrated circuit 261 of the second printed circuit board 240 receives a portion of the parameters from the storage unit 250 and transmits the same to the programmable gamma IC 260 by a pair of a serials data line (SDA) and a serials clock line (SCL) 291. The timing controller 270 receives another portion of parameters from the storage unit 250 by a pair of a serials data line (SDA) and a serials clock line (SCL) 292. The programmable gamma IC 260 and the timing controller 270 receive and adjust the parameters, and then the second printed circuit board 240 transmits a signal to the first printed circuit board 230. The first printed circuit board 230 passes the signal received from the second printed circuit board 240 to the driving circuit 220. Subsequently, the driving circuit 220 provides driving signals to the signal lines (not shown) of the display panel 210 for driving pixels, so as to accomplish displaying.

According to the embodiment of the present invention, it will be understood that the present invention may provide various display devices as required. For example, the second printed circuit board 240 only includes the programmable gamma IC 260 or the timing controller 270. In the same way, those display devices also apply to the technical solution of the present invention.

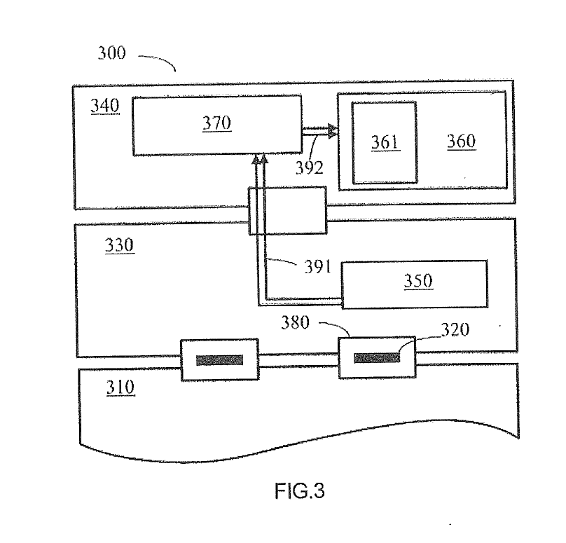

The display device 300 of the second embodiment of the present invention is similar to that of the first embodiment. As shown in FIG. 3, a second printed circuit board 340 includes a programmable gamma IC 360, a timing controller 370, and an inner-integrated circuit 361. The timing controller 370 is connected between a storage unit 350 and the programmable gamma IC 360. The timing controller 370 receives a portion of parameters from the storage unit 350 by a pair of SDA and SCL signal lines 391, and transmits the same to an inner integrated circuit 361. The inner integrated circuit 361 receives the parameters through the timing controller 370 and transmits them to the programmable gamma IC 360 by a pair of a serials data line (SDA) and a serials clock line (SCL) 392. As discussed above, for obtaining the parameters that the programmable gamma IC 360 need, the timing controller 370 may read entire parameters which are needed by the programmable gamma IC 360 and the timing controller 370 from the storage unit 350 at once, and then the timing controller 370 transmits a portion of parameters to the programmable gamma IC 360. In another embodiment, the timing controller 370 reads a portion of parameters from the storage unit 350 when the programmable gamma IC 360 requests for the parameters, and then the timing controller 370 transmits the parameters to the programmable gamma IC 360. After the timing controller 370 and the programmable gamma IC 360 receive the parameters from the storage unit 350, the process for driving the display panel 310 is the same as that in the above embodiment.

Although the invention herein, with reference to several illustrative embodiments, has been described for the present invention, it should be understood to an ordinary skilled person in the art that the invention is not limited to the embodiments, but rather that various changes or modifications thereof are possible without departing from the spirit of the invention.

What is claimed is:

1. A display device including:
a display panel having a plurality of pixels;
a driving circuit for generating a plurality of driving signals to drive the pixels of the display panel;
a first printed circuit board electrically connected to the driving circuit, and a storage unit deployed in the first printed circuit board for storing parameters which are used for driving the pixels of the display panel; and
a second printed circuit board electrically connected to the first printed circuit board for receiving the parameters stored in the storage unit, and having a programmable gamma IC and a timing controller provided thereon,
wherein the timing controller is connected between the programmable gamma IC and the storage unit, the timing controller receives a portion of parameters from the storage unit, and the programmable gamma IC receives another portion of parameters from the storage unit through the timing controller;
the programmable gamma IC receives the portion of parameters by an inner integrated circuit; and
the inner integrated circuit is deployed in the programmable gamma IC.

2. A display device including:
a display panel having a plurality of pixels;
a driving circuit for generating a plurality of driving signals to drive the pixels of the display panel;
a first printed circuit board electrically connected to the driving circuit, and a storage unit deployed in the first printed circuit board for storing parameters which are used for driving the pixels of the display panel; and
a second printed circuit board electrically connected to the first printed circuit board for receiving the parameters stored in the storage unit.

3. The display device as claimed in claim 2, wherein the second printed circuit board comprises a programmable gamma IC connected with the storage unit for receiving a portion of parameters from the storage unit, and transmits the same to the driving circuit for generating driving signals.

4. The display device as claimed in claim 2, wherein the second printed circuit board comprises a programmable gamma IC and a timing controller, the programmable gamma IC is connected with the storage unit for receiving a portion of parameters from the storage unit, and the timing controller is connected with the storage unit for receiving another portion of parameters from the storage unit.

5. The display device as claimed in claim 4, wherein the second printed circuit board further comprises an inner-integrated circuit, and the programmable gamma IC receives the parameters from the storage unit by the inner-integrated circuit.

6. The display device as claimed in claim 5, wherein the inner-integrated circuit is deployed in the programmable gamma IC.

7. The display device as claimed in claim 2, wherein the second printed circuit board comprises a timing controller connected with the storage unit for receiving a portion of parameters from the storage unit, and transmits the same to the driving circuit for generating driving signals.

8. The display device as claimed in claim 2, wherein the second printed circuit board comprises programmable gamma IC and a timing controller, the timing controller is connected between the programmable gamma IC and the storage unit, the timing controller receives a portion of parameters from the storage unit, and the programmable gamma IC receives another portion of parameters from the storage unit through the timing controller.

9. The display device as claimed in claim 8, wherein the second printed circuit board further comprises an inner-integrated circuit, and the programmable gamma IC receives the parameters from the storage unit by the inner-integrated circuit.

10. The display device as claimed in claim 9, wherein the inner-integrated circuit is deployed in the programmable gamma IC.

11. The display device as claimed in claim 1, wherein the parameters stored in the storage unit include at least one kind of values of an overdrive look-up table, a color look-up table, and a de-mura look-up table.
